(19) United States
(12) Patent Application Publication
(10) Pub. No.: US 2017/0167763 A1
(43) Pub. Date: Jun. 15, 2017

(54) Heat Engine And Method For Operating A Heat Engine

(71) Applicant: Siemens Aktiengesellschaft, Muenchen (DE)

(72) Inventors: Vladimir Danov, Erlangen (DE); Florian Reissner, Nuernberg (DE)

(73) Assignee: Siemens Aktiengesellschaft, Muenchen (DE)

(21) Appl. No.: 15/115,997

(22) PCT Filed: Feb. 4, 2015
(86) PCT No.: PCT/EP2015/052241

§ 371 Date: Aug. 2, 2016

(30) Foreign Application Priority Data
Feb. 11, 2014 (DE) 10 2014 202 429.3

(51) Int. Cl. F25B 31/00; B01F 5/06; B01F 13/08; F25B 30/02; B01F 3/08

(52) U.S. Cl. CPC F25B 31/004; F25B 30/02; B01F 3/0807; B01F 13/0818; B01F 5/0614; F25B 2500/16; B01F 2215/0065

(57) ABSTRACT

A heat engine having a circuit system which conducts a fluid and which may include at least one evaporation device for evaporating the fluid, at least one compression device for compressing the fluid, at least one condensation device for condensing the fluid, an accumulation device for accumulating the fluid and a further fluid, which can be added to the fluid by means of the compression device, can be accumulated, and at least one expansion for expanding the fluid. The accumulation device may include a mixing device for mixing the fluid and the further fluid to form an emulsion. A method for operating such a heat engine is also provided.

### CROSS-REFERENCE TO RELATED APPLICATIONS

This application is a U.S. National Stage Application of International Application No. PCT/EP2015/052241 filed Feb. 4, 2015, which designates the United States of America, and claims priority to DE Application No. 10 2014 202 429.3 filed Feb. 11, 2014, the contents of which are hereby incorporated by reference in their entirety.

### TECHNICAL FIELD

The invention relates to a combined heat and power machine with a circuit system which conducts a fluid, having at least one evaporation device, by means of which the fluid can be evaporated, having at least one compression device, by means of which the fluid can be compressed, having at least one condensation device, by means of which the fluid can be condensed, having at least one accumulation device, by means of which the fluid and a further fluid, which can be added to the fluid by means of the compression device, can be accumulated, and having at least one expansion device, by means of which the fluid can be expanded. The invention also relates to a method of operating such a combined heat and power machine.

### BACKGROUND

In combined heat and power machines, which include heat pumps and refrigeration systems, mechanical energy is used to increase heat energy from a relatively low temperature level to a higher temperature level. Both in refrigeration systems and in heat pumps, use is usually made of oil-lubricated compressors for the purpose of compressing a fluid. Following the operation of the fluid being compressed, and prior to the operation of the fluid being condensed in the condenser, use is made of oil separators, by means of which oil exiting from the compressor or some other compression device is separated from the fluid, wherein the entrained oil is then conducted back into the compressor. Complete separation is generally not possible, and therefore some of the entrained oil also passes into a condenser of the refrigeration system or heat pump. Specifically in the case of relatively large installations (>20 kW), an accumulator is installed downstream of the condenser. Said accumulator serves to store the fluid and the oil contained therein, and it is therefore always the case that free-flowing fluid passes into an expansion valve (expansion device) provided downstream of the accumulator, as seen in the fluid-flow direction. The accumulator can also provide for operational fluctuations, changes in load or alterations in temperature on the heat-source or heat-sink side of the combined heat and power machine. Such an accumulator is necessary particularly in installations having a plurality of evaporators.

However, in addition to other physical properties, the fluid used in the respective combined heat and power machine should have a suitable density in relation to the oil (compressor oil) and should also be miscible with the oil. This avoids the situation where the fluid has for example a higher density than the oil, in which case the oil would float in the accumulator, accumulate there over a long period of time and would not pass back into the compressor. Using the fluids (e.g. R134a) which are miscible with the compressor oil results in floating oil being dissolved in the fluid and being able to flow to the expansion valve with the fluid.

### SUMMARY

One embodiment provides a combined heat and power machine including a circuit system that conducts a fluid and which includes at least one evaporation device, by means of which the fluid can be evaporated, having at least one compression device, by means of which the fluid can be compressed, having at least one condensation device, by means of which the fluid can be condensed, having at least one accumulation device, by means of which the fluid and a further fluid, which can be added to the fluid by means of the compression device, can be accumulated, and having at least one expansion device, by means of which the fluid can be expanded, wherein the accumulation device comprises a mixing device, by means of which the fluid and the further fluid can be mixed to form an emulsion.

In one embodiment, the mixing device is arranged upstream of the accumulation device, as seen in the fluid-flow direction.

In one embodiment, the further fluid is in the form of a compressor oil.

In one embodiment, the mixing device has a stirrer, which is designed in the form of a static mixer.

In one embodiment, the accumulation device has a magnetic stirrer.

In one embodiment, the magnetic stirrer has a plurality of metallic blades.

In one embodiment, the accumulation device has a solenoid, which is arranged on its peripheral region and by means of which the magnetic stirrer can be rotated.

In one embodiment, the accumulation device has an accumulator, which is formed from a non-magnetic material.

Another embodiment provides a method of operating a combined heat and power machine, having the following steps: evaporating a fluid by means of at least one evaporation device, compressing the fluid by means of at least one compression device, condensing the fluid by means of at least one condensation device, accumulating the fluid and a further fluid, which is added to the fluid by means of the compression device, by means of an accumulation device, which comprises an accumulator, and expanding the fluid by means of an expansion device, wherein the accumulation device comprises a mixing device for mixing the fluid with the further fluid to form an emulsion.

### BRIEF DESCRIPTION OF THE DRAWINGS

Example aspects and embodiments of the invention are described below with reference to the figures, in which:

FIG. 1 shows a schematic illustration of a circuit system of a heat pump as an example of a combined heat and power machine, wherein use is made of an accumulator which is known from the prior art and is intended for accumulating a fluid and a further fluid, which is in the form of a compressor oil;

FIG. 2 shows an embodiment known from the prior art, wherein, for the purpose of emptying the accumulator, a hot-gas bypass leads into the accumulator from a pressure side of a compression device in the form of a compressor;

FIG. 3 shows a schematic illustration of a circuit system of a combined heat and power machine designed in this case in the form of a heat pump, wherein an accumulation device of the combined heat and power machine has a mixing device according to an example embodiment of the invention, which is designed in the form of a static mixer and by means of which an emulsion can be produced from the fluid and the further fluid; and

FIG. 4 shows a further schematic illustration of a further embodiment of the accumulation device, wherein the mixing device comprises a magnetic stirrer with metallic blades and also comprises a solenoid arranged on a peripheral region of the accumulation device.

### DETAILED DESCRIPTION

Embodiments of the present invention provide a combined heat and power machine, and also a method of operating such a combined heat and power machine, in which, even in the case of the fluids used in the combined heat and power machine having high densities and being non-miscible, e.g., smooth operation takes place.

In order for it also to be possible to make use, in the combined heat and power machine, of fluids which differ greatly from one another in terms of density and, in addition or as an alternative, are not miscible with one another, the accumulation device may comprise a mixing device, by means of which the fluid and the further fluid can be mixed to form an emulsion.

Using such a mixing device produces as homogeneous as possible a mixture between the fluid used in the combined heat and power machine, said fluid serving as a working fluid, and the further fluid, which is separated out for example from the compression device (e.g. compressor) and is in the form, for example, of compressor oil. The mixing device thus distributes the further fluid particularly uniformly in the fluid, even if the fluid and the further fluid differ considerably from one another in terms of density, that is to say the fluid has a considerably higher or even lower density than the further fluid, or even if the further fluid is not miscible with the fluid. In other words, it is possible to generate an emulsion from the disperse phase (further fluid) and the continuous phase (condensed and therefore free-flowing fluid) because the collecting device comprises the mixing device. Production of this emulsion allows finely distributed oil droplets of the compressor oil to pass to the expansion valve together with the fluid, as a result of which homogeneous distribution of the two fluids in the emulsion is achieved particularly effectively even if there are considerable differences in density between the fluid and the further fluid. This means that, on the one hand, concentration-induced operational fluctuations as a result of poor or inhomogeneous mixing of the fluid with the further fluid of the combined heat and power machine and also an insufficient supply of lubricant to the compressor (compression device) can be particularly largely avoided.

In one embodiment, the mixing device is arranged upstream of the accumulation device, as seen in the fluid-flow direction.

By providing the mixing device upstream of the accumulation device, the fluid exiting from the condensation device (condenser) and the further fluid are passed onward in the form of a particularly homogeneous emulsion to the accumulator. It has been found to be further advantageous if the further fluid is in the form of a compressor oil.

The homogeneous mixing of the fluid with the further fluid (compressor oil) ensures to particularly good effect that an insufficient supply of lubricant to the compression device (compressor) is avoided. In other words, particularly uniform lubrication of the compressor is thus ensured by the compressor oil distributed homogeneously in the fluid.

The mixing device may include a stirrer, e.g., a static mixer.

A stirrer constitutes a particularly cost-effective and efficient option for mixing the fluid with the further fluid to form an emulsion, in particular if the stirrer is designed in the form of a static mixer. The static mixer comprises flow-influencing elements which form, for example, a screw shape and alternately divide up, and then bring together again, the fluid stream. In other words, the flow movement of the fluid and of the further fluid causes these to be mixed in a particularly efficient manner and, accordingly, produces a particularly homogeneous emulsion with particularly uniform distribution of extremely small droplets of the further fluid in the fluid. The mixing device is designed, for example, in the form of the static stirrer accommodated in a section of pipe.

In one embodiment, the accumulation device has a magnetic stirrer.

Such a magnetic stirrer may be of particularly compact design and can thus be used in a particularly constricted amount of space for the purpose of forming the emulsion from the fluid and the further fluid.

In one embodiment, the magnetic stirrer has a plurality of metallic blades.

Using the metallic blades distributes the further fluid particularly quickly and particularly homogeneously in the fluid, wherein the magnetic stirrer and the metallic blades can extend, for example, as far as the periphery of the accumulation device and particularly intensive stirring or circulation of the mixture made up of the fluid and the further fluid can thus be achieved. The metallic blades thus constitute, in other words, particularly straightforward and efficient turbulence generators for producing the homogeneous mixture in the form of the emulsion.

In one embodiment, the accumulation device has a solenoid, which is arranged on its peripheral region and by means of which the magnetic stirrer can be rotated.

The magnetic stirrer can be rotated in a contactless manner by means of the solenoid, wherein there is no need for complicated coupling of the magnetic stirrer to a mechanical drive unit, such as for example an electric motor, and sealing of respective coupling elements, for example driveshafts, in relation to a fluid outlet. The peripheral region here corresponds, for example, to the outer wall (or outer lateral surface) of a container which accommodates the fluid and the further fluid and is designed, for example, in the form of an accumulator and in which the magnetic stirrer is accommodated.

In one embodiment, the accumulation device has an accumulator, which is formed from a non-magnetic material.

The accumulator corresponds to an accumulation-device container in which the fluid and the further fluid, which exit from the condensation device, are accumulated and stored for further use. If the accumulator is formed from a non-magnetic material (e.g. non-magnetic stainless steel), then it is also possible for a magnetic stirrer driven by a solenoid to be used particularly efficiently and without disruption being caused (by the accumulator) to a magnetic field built up by the solenoid.

In the case of the method of operating a combined heat and power machine with a fluid, said fluid is evaporated by means of at least one evaporation device, is compressed by means of a compression device, is condensed by means of at least one condensation device and is accumulated together with a further fluid, which is added to the fluid by means of the compression device, by means of an accumulation device, which comprises an accumulator, and the fluid is expanded by means of an expansion device. The accumulation device comprises a mixing device for mixing the fluid with the further fluid to form an emulsion.

Formation of as homogeneous as possible an emulsion from the fluid and the further fluid particularly largely suppresses concentration-induced operational fluctuations of the combined heat and power machine, wherein a particularly uniform and continuous supply of lubricant to the compression device is ensured in addition.

FIG. 1 shows, in the schematic illustration, a combined heat and power machine 1 which is designed in the present case in the form of a heat pump. In the combined heat and power machine 1, a circuit system 2 is formed by an evaporation device 3, designed in the form of an evaporator, together with a compression device 4, which is designed in the form of a compressor, and with a condensation device 5, which is designed in the form of a condenser, and an expansion device 7, which is designed in the form of an expansion valve. The circuit system 2 contains a pipe system (not illustrated in any more detail here), which conducts a fluid 16. The fluid 16 here corresponds to a fluid which is used in the combined heat and power machine 1 and is subjected to evaporation, compression, condensation and subsequent expansion. It is usually the case that a further fluid 17 is separated from the compression device 4 during operation of the same. This further fluid 17 here corresponds, in the present case, to compressor oil, which is used as a lubricant for the purpose of maintaining smooth operation of the compression device 4. It is undesirable for the further fluid (compressor oil) to be separated out into the circuit system 2 of the combined heat and power machine 1, but this cannot be avoided altogether. The fluid 16 and the further fluid 17, which is added to the fluid 16 by means of the compression device 4, are moved within the circuit system 2 of the combined heat and power machine 1 along a fluid-flow direction 10 indicated by an arrow.

In order to avoid insufficient supply of lubricant to the compression device, that is to say the compressor, the combined heat and power machine 1 comprises an accumulation device 6 with an accumulator 9. The accumulator 9 here serves for storing the fluid 16, and it is therefore always the case that free-flowing fluid 16 passes into the expansion valve, that is to say the expansion device 7. This is also ensured in the case of operational fluctuations, changes in load or alterations in temperature on the heat-source or heat-sink side of the combined heat and power machine 1, provided the fluid 16 and the further fluid 17 are miscible with one another and the fluid 16 has a density which is lower than or equal to that of the further fluid 17. Only then it is ensured that the further fluid 17, rather than floating at the top (on the fluid 16) in the accumulator 9, passes back to the compression device 4 via the expansion device 7.

In order to ensure smooth operation of the combined heat and power machine 1 according to the embodiment in FIG. 1, which is known from the prior art, the fluid 16 used should therefore have a lower density than the further fluid 17 (compressor oil). If this is the case, then the further fluid 17 flows downward of its own accord in the accumulator 9 to the expansion device 7, that is to say to the expansion valve. In accordance with the prior art, it is therefore necessary to use fluids 16 (e.g. R134a) which are miscible with the further fluid 17. The miscibility means that the floating compressor oil is dissolved in the fluid 16 and can flow to the expansion valve with said fluid 16.

The figures which will be described herein below also contain features which have already been explained with reference to FIG. 1, for which reason said features will not be discussed anew herein below.

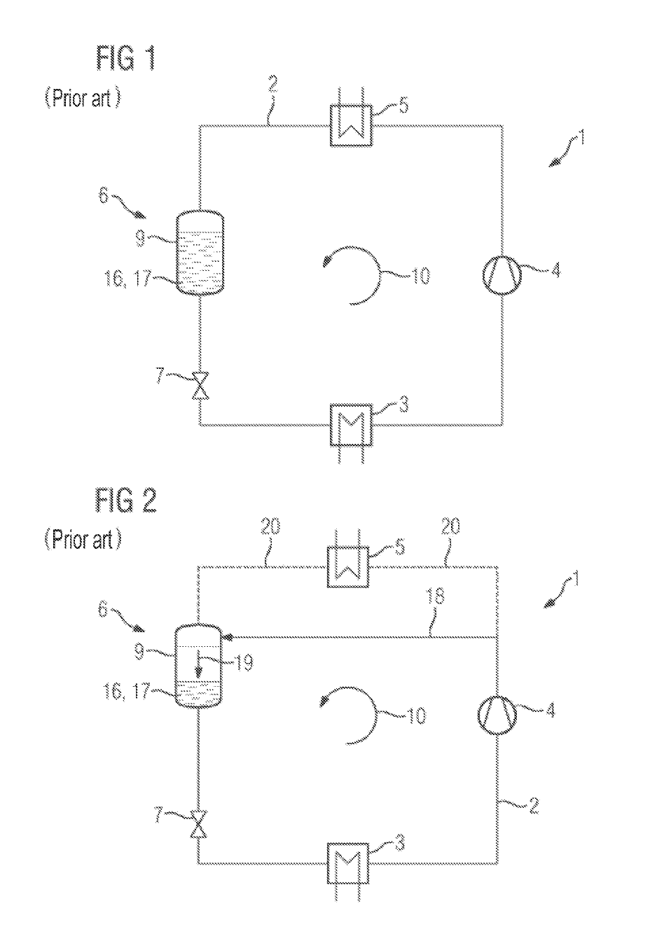

FIG. 2 uses a further schematic illustration of the combined heat and power machine 1 to show a hot-gas bypass 18, which connects a pressure side of the compression device 4 to the accumulator 9. The pressure side here corresponds to a location in the circuit system 2 downstream of the compression device 4, and upstream of the condensation device 5, as seen in the fluid-flow direction 10. As a result of direct fluid-vapor action by way of the compressed fluid 16 and the further fluid 17 (compressor oil) entrained therein, the mixture contained in the accumulator 9, and made up of the fluid 16 and the further fluid 17, is emptied along a direction 19 denoted by an arrow, and thereafter, the further fluid 17, which is separated from the fluid 16, is fed, in turn, to the compression device 4. While the hot-gas bypass 18 is active and, accordingly, the compressed mixture made up of the fluid 16 and the further fluid 17 is being delivered from the pressure side of the compression device 4 into the accumulator 9, there is no condensation, and therefore no heat dissipation, taking place. In other words, it is therefore the case, during the operation of the accumulator 9 being emptied as a result of the fluid-vapor action, that the condensation device 5, that is to say the condenser, is at a standstill by way of the hot-gas bypass 18.

Accordingly, respective lines 20 which connect the condensation device 5 to the compression device 4 and to the accumulation device 6 do not have the mixture made up of the fluid 16 and the further fluid 17 flowing through them during the course of the fluid-vapor action. This solution is highly laborious and inefficient since, despite the compression device 4 being in continuous operation, there is no heat dissipation taking place via the condensation device 5 and also the combined heat and power machine 1 equipped with the hot-gas bypass 18 requires a high level of maintenance and monitoring. The monitoring work is increased, for example, because it is necessary to monitor when the accumulator 9 has been emptied and, accordingly, the fluid-vapor action finishes again in the empty state and the condensation device 5 can have flow passing through it again. The emptying of the accumulator 9 has to be monitored, in particular, because there is the risk of the accumulator 9 being subjected to too high a temperature if it is empty over a relatively long period of time.

The embodiments which are known from the prior art are unsuitable as soon as the fluid 16 used is an operating means which has a higher density than the further fluid 17 (compressor oil) and, in addition or as an alternative, is not miscible with the further fluid 17, since it is then not possible to ensure that the further fluid 17 is conducted back to the compression device 4.

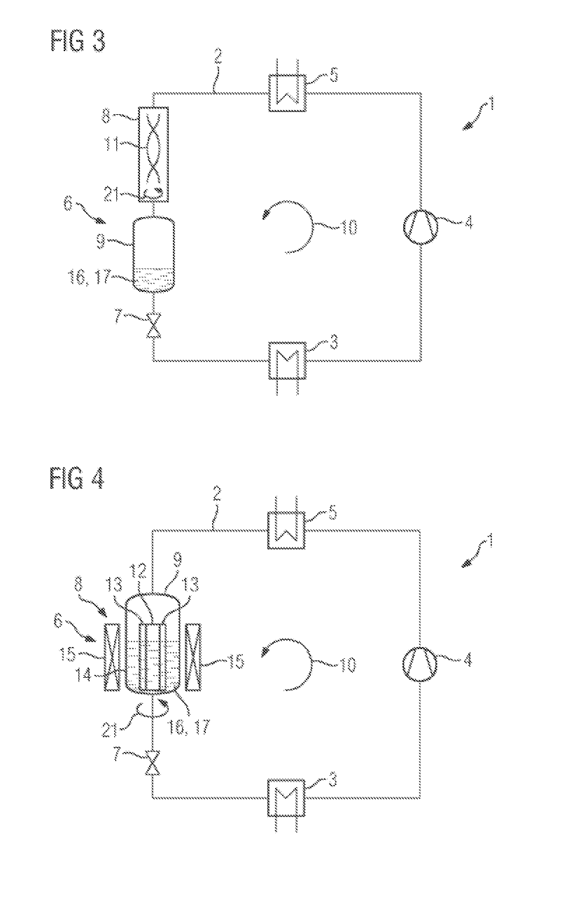

In order for it also to be possible for the fluid 16 used to be operating means which have a higher density than the further fluid 17, which in the present case corresponds to a compressor oil, and/or are not miscible with the further fluid 17, embodiments as are illustrated herein below with reference to FIGS. 3 and 4 are particularly suitable.

In the exemplary embodiments shown in FIGS. 3 and 4, the accumulation device 6 comprises a mixing device 8, by means of which the fluid 16 and the further fluid 17 can be mixed to form an emulsion. The mixing device 8 shown in FIG. 3 has a stirrer 11, which is defined in the form of a static mixer and is arranged upstream of the accumulation device 6, as seen in the fluid-flow direction 10. In other words, it is therefore the case that the fluid 16, which exits from the condensation device 5, and the further fluid 17 are mixed by means of the mixing device 8 to form an emulsion made up of a disperse phase, comprising the further fluid 17 (compressor oil), and a continuous phase, comprising the fluid 16, which is free-flowing as a result of the preceding condensation. The oil droplets of the further fluid 17 are thus distributed particularly finely in the fluid 16 by means of the mixing device 8. In this state, the finely distributed oil droplets together with the fluid 16 are passed onward to the expansion valve, that is to say to the expansion device 7. The mixing device may be of particularly straightforward configuration and, accordingly, may comprise a rectilinear section of pipe, in which the stirrer 11 rotates in accordance with a rotary movement 21 denoted by an arrow. Depending on the subsequent residence time of the emulsion in the accumulator 9, a more or less pronounced distribution, and consequently a more or less pronounced stirring by the stirrer 11 of the mixing device 8, is necessary in order for particularly fine oil droplets (of the further fluid 17) to be distributed in the working fluid (fluid 16).

In the combined heat and power machine 1 in the exemplary embodiment shown in FIG. 4, provision is made for the accumulation device 6 to have a magnetic stirrer 12 with a plurality of metallic blades 13. Furthermore, the accumulation device 6 has a solenoid 15, which is arranged on the peripheral region 14 of said accumulation device and by means of which the magnetic stirrer 12 can be rotated in accordance with the rotary movement 21. The peripheral region 14 corresponds, in the present case, to the outer surface of the container wall of the accumulator 9. The magnetic stirrer 12 here is installed in the accumulator 9, that is to say the container or accumulator container, and is rotated by way of a travelling magnetic field of the solenoid 15. In order to ensure that the magnetic stirrer 12 is driven by means of the solenoid 15, the accumulator 9 is formed from a non-magnetic material.

The embodiment which is presented in FIG. 3 manages without any additional components, for example the solenoid 15, but has limitations for accumulators 9 in which the emulsion is to be stored over a relatively long residence time. In order to prevent separation of the fluid 16 and the further fluid 17 even in the case of relatively long residence times of the emulsion made up of said two fluids 16, 17, the embodiment with the solenoid 15, which is presented in FIG. 4, is particularly suitable.

The aim in the mixing device 8, using the stirrer 11, is thus to achieve active mixing of the two fluids 16, 17. The formation of the emulsion by means of the mixing device 8 makes it possible to use fluids 16 irrespective of their density and their mixing behavior with the respective further fluid 17 in the combined heat and power machine 1, wherein there is no interruption in the dissipation of heat at the condensation device 5 and no complex maintenance work required.

What is claimed is:

1. A combined heat and power machine, comprising:
a circuit system that conducts a fluid, circuit system comprising:
at least one evaporation device configured to evaporate the fluid,
at least one compression device configured to compress the fluid,
at least one condensation device configured to condense the fluid,
at least one accumulation device configured to accumulate the fluid and a further fluid added to the fluid by the compression device, and
at least one expansion device configured to expand the fluid,
wherein the accumulation device comprises a mixing device configured to mix the fluid and the further fluid to form an emulsion.

2. The combined heat and power machine of claim 1, wherein the mixing device is arranged upstream of the accumulation device, with respect to a main fluid-flow direction of the fluid.

3. The combined heat and power machine of claim 1, wherein the further fluid comprises a compressor oil.

4. The combined heat and power machine of claim 1, wherein the mixing device comprises a static mixer.

5. The combined heat and power machine of claim 1, wherein the accumulation device includes a magnetic stirrer.

6. The combined heat and power machine of claim 5, wherein the magnetic stirrer includes a plurality of metallic blades.

7. The combined heat and power machine of claim 5, wherein the accumulation device includes a solenoid is arranged at a peripheral region of the accumulation device, and which rotates the magnetic stirrer.

8. The combined heat and power machine of claim 1, wherein the accumulation device includes an accumulator formed from a non-magnetic material.

9. A method of operating a combined heat and power machine, the method comprising
evaporating a fluid using at least one evaporation device,
compressing the fluid using at least one compression device,
condensing the fluid using at least one condensation device,
accumulating the fluid and a further fluid, which is added to the fluid by means of the compression device, using an accumulation device that comprises an accumulator, and
expanding the fluid using an expansion device,
wherein the accumulation device comprises a mixing device configured to mix the fluid with the further fluid to form an emulsion.

10. The method of claim 9, wherein the mixing device is arranged upstream of the accumulation device, with respect to a main fluid-flow direction of the fluid.

11. The method of claim 9, wherein the further fluid comprises a compressor oil.

12. The method of claim 9, wherein the mixing device comprises a static mixer.

13. The method of claim 9, wherein the accumulation device includes a magnetic stirrer.

14. The method of claim 13, wherein the magnetic stirrer includes a plurality of metallic blades.

15. The method of claim 13, wherein the accumulation device includes a solenoid is arranged at a peripheral region of the accumulation device, and which rotates the magnetic stirrer.

16. The method of claim 9, wherein the accumulation device includes an accumulator formed from a non-magnetic material.
